(19) United States
(12) Patent Application Publication
(10) Pub. No.: US 2003/0051163 A1
(43) Pub. Date: Mar. 13, 2003

(54) Distributed network architecture security system

(76) Inventor: Olivier Bidaud, Toulouse (FR)

Correspondence Address: Dike, Bronstein, Roberts & Cushman, Intellectual Property Practice Group, Edwards & Angell, LLP, P.O. Box 9169, Boston, MA, 02209, US

(21) Appl. No.: 10/118,632

(22) Filed: Apr. 8, 2002

Related U.S. Application Data
(60) Provisional application No. 60/322,019, filed on Sep. 13, 2001.

(51) Int. Cl. G06F 11/30

(52) U.S. Cl. 713/201

(57) ABSTRACT

A system for assessing the vulnerability of a network is disclosed and comprises a central console and a plurality of agents disposed on the network for performing active tests under control of the central console. The agents probe the network for vulnerabilities, and communicate the results of the tests to said central console, where a report on the security of the network is prepared.

### CROSS REFERENCE TO RELATED APPLICATIONS

Priority is claimed from provisional application Serial No. 60/322,019, filed Sep. 13, 2001.

### FIELD OF THE INVENTION

This invention relates to network security systems, and more particularly, to a method and system for actively assessing the security of a computer network.

### BACKGROUND OF THE INVENTION

Recently, there has been a large growth in the demand for secure networks, particularly networks connected to the Internet. The tremendous growth in the usage of the Internet to conduct business has been the main market driver for the growth in the Internet security market. The need to protect data, corporate information technology (IT) infrastructure and electronic business processes has led companies to invest more and more in protecting their most important asset, information.

The market for secure networks, however, has not been confined to computer networks. The increased integration of the Internet and internal corporate IT networks has also fueled this growth. The broader market encompasses the security assessment of a company's total IT infrastructure, and includes such items as enterprise resource planning (ERP) systems, remote access systems, and intranet systems. The broader market is eventually expected to include security assessment of emerging technologies such as Voice over IP (VoIP), wireless data, and broadband. All of these systems are vulnerable to attack by a malicious intruder, and as their importance to the enterprise increases, so does the need for security.

Awareness of the need for secure networks has also increased dramatically as a result of publicity in the news media regarding the damage caused by computer viruses, thus creating an even higher demand for security.

Preventing, detecting and managing networks and systems security are generally considered the three layers of the emerging security management market. Security specialists consider prevention as the least costly step; in particular, security testing is the least expensive way to protect networks and systems against attacks.

Security testing technology has developed rapidly during the last few years, beginning with the first simple hacker tools, and now including highly complex, automated scanning tools. The tools require trained operators in order to be effective, and the increased demand for secure networks has created a concomitant shortage of qualified personnel. As a result of the demand for secure networks and the shortage of qualified personnel, the most popular network security tools are passive systems, which merely react only when an intrusion is detected. One reason this solution is popular is because it requires a minimum of security personnel to install and operate.

Passive systems, of course, can respond only to previously identifiable attacks from intruders. As a result, passive systems suffer from drawbacks. Passive systems require an attack signature, indicating the nature and type of attack, in order to block or detect the attack. This may be telltale exploit code or a source address of the attacker. Unfortunately, the only way to get an attack signature is for a network to be attacked first. Once the signature of the attack is identified, of course, the software can be reconfigured to block the attack. However, the attack may have done significant damage before remediation occurs.

One proposed solution to the drawbacks of a passive system has been an active system. An active system probes a network for vulnerabilities before an intrusion ever occurs. It does this by running test cases. Some of the test cases probe for known weaknesses, while others simulate a possible attack. Known active systems run test cases from a central point in order to perform an assessment of the vulnerability of the entire network.

A problem arises from running test cases from a central point to determine network vulnerabilities, however. Running the tests consumes scarce bandwidth, and can easily create a bottleneck on the network. This is especially true if thousands of test cases are run on thousands of machines. One solution to the bottleneck problem has been to run the tests less frequently. This, of course, is not desirable, as it leaves the network more vulnerable to attack. A second solution to the bottleneck problem has been to install duplicate scanners throughout the network.

Duplicate scanners, which scan only a sub-network of the entire network, also have problems. When duplicate scanners are installed on the network, each scanner produces its own report on the security of the sub-network it has tested. In order to get a complete picture of the security status of the entire network, each report run on each sub-network must be consolidated by a skilled security specialist at a central point. This is a difficult and time-consuming process, especially if a large number of reports are involved. It is particularly problematic when there are insufficient security specialists available to perform the task, a common occurrence in corporate IT departments.

A further problem arises from running test cases from a central point where there are firewalls installed in the sub-networks. Firewalls, of course, are needed to protect a network from outside intrusion. However, they pose an obstacle to centralized testing of large networks, as they inhibit two-way communication between the central test station and the sub-networks. The firewall, which keeps out malicious intruders, also keeps out, or at least limits the effectiveness of, the tests.

### SUMMARY OF THE INVENTION

According to the present invention, a network security system comprises agents, which are distributed throughout the network and perform tests, and a central console that controls the operations and configurations of the agents. The console manages the communication and the configuration of the test engines, both local and remote, distributes the tasks between the local and remote engines, stores the results in a central repository, and provides the operator with real-time feedback on the scan process progress in interactive mode.

In accord with the present invention, a system for assessing the vulnerability of a network comprises a central console and an agent disposed on the network for performing active tests under control of the central console. The agent communicates the results of the tests to the central console.

Also in accord with the present invention, a method of assessing the security of a network comprises the steps of deploying an agent on the network, and directing the agent from a central console to run tests on the network to assess the vulnerability of the network to attack.

Further in accord with the present invention, a network security system comprises a central console, and an agent disposed on the network for performing active tests under control of the central console. The agent communicates the results of the tests to the central console. A report module provides a report on the security of the network in response to the results of the tests.

Even further in accord with the present invention, a network security assessment method comprises the steps of deploying an agent on the network, directing the agent from a central console to run active tests on the network to assess the vulnerability of the network to attack, and compiling the results of the tests.

Still further in accord with the present invention, a computer program product comprises a computer usable medium having computer readable program code embodied in the medium for causing an application program to execute on a computer to provide an assessment of the vulnerability of a network of computers. The computer readable program code comprises a first computer readable program code executing on at least one computer on the network for performing active tests on the network, and a second computer readable program code for sending instructions to the first computer readable program code to perform the tests and for receiving the results of the tests run by the first computer readable program code.

Also in accord with the present invention, a computer data signal is embodied in a carrier wave representing sequences of instructions which, when executed by a processor, assess the vulnerability of a network of processors. The computer data signal comprises a first program code segment executing on at least one processor on the network for performing active tests on the network, and a second program code segment for sending instructions to the first program code segment to perform the tests and for receiving the results of the tests run by the first program code segment.

### BRIEF DESCRIPTION OF THE DRAWINGS

FIG. 1 is a block diagram of a distributed network scanning architecture system according to the present invention;

FIG. 2 is a block diagram of a sub-network of the network of FIG. 1;

FIG. 3 is a block diagram of a sub-network of the network of FIG. 1 with a firewall between two sub-networks;

FIG. 4 is a block diagram of a sub-network of the network of FIG. 1 coupled to the Internet;

FIG. 5 is a flowchart for the console depicted in FIG. 1;

FIG. 6 is a flowchart for an agent depicted in FIG. 1;

FIG. 7 is a flowchart for the report generator depicted in FIG. 1;

FIG. 8 is a functional block diagram showing the modules of the console depicted in FIG. 1;

FIG. 9 is a functional block diagram showing the modules of the agent depicted in FIG. 1;

FIG. 10 is a flowchart for the program of the test manager depicted in FIG. 8;

FIG. 11 is a flowchart for the program of the communication manager of FIG. 8;

FIG. 12 is a flowchart for an alternate embodiment of the system of FIG. 1;

FIG. 13 is a flowchart for the program of the test manager of FIG. 8;

FIG. 14 is a flowchart for the program of the test engine of FIG. 8;

FIG. 15 is a flowchart for the program of a virtual test engine;

FIG. 16 is a flowchart for the program of a remote test engine;

FIG. 17 is a global flowchart illustrating the interactions of the modules of the system of FIG. 1 when the modules are initialized;

FIG. 18 is a global flowchart illustrating the interactions of the modules of the system of FIG. 1 when communications between the modules are established and synchronized;

FIG. 19 is a global flowchart illustrating the interactions of the modules of the system of FIG. 1 when the modules begin running tests on the network; and

FIG. 20 is a global flowchart illustrating the interactions of the modules of the system of FIG. 1 when the modules are running tests on the network.

### DETAILED DESCRIPTION OF THE PREFERRED EMBODIMENTS

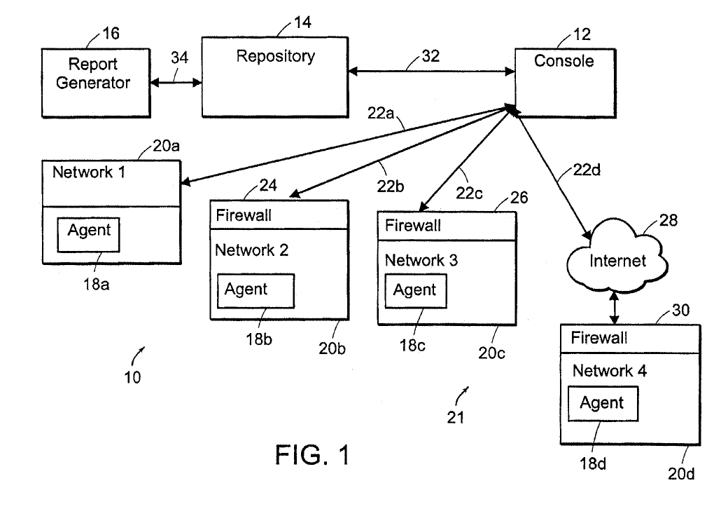

Referring to the drawings, and initially to FIG. 1 thereof, a distributed network scanning architecture system 10 comprises a central console 12, a repository 14 connected thereto, and a report generator 16 connected to the repository 14. The console 12 is connected to a plurality of agents 18a, 18b, 18c, 18d (indicated generally by the reference numeral 18), disposed on a plurality of sub-networks or networks 20a, 20b, 20c, 20d (indicated generally by the reference numeral 20), collectively comprising a network system 21. The console 12 communicates with the agents 18a, 18b, 18c, 18d on the networks 20a, 20b, 20c, 20d (indicated also in the figures as network 1, network 2, network 3, and network 4, respectively) through lines of communication indicated diagrammatically in FIG. 1 by the double headed arrows 22a, 22b, 22c, and 22d. Various protocols may be used to communicate along the lines 22a, 22b, 22c, 22d, as will be evident to those of skill in the art.

Each network 20a, 20b, 20c, 20d is configured differently according to the requirements of the particular application. For example, in the network 20b, a firewall 24 is disposed between the console 12 and the computers connected to the network 20b. In the network 20c, a firewall 26 is disposed between the console 12 and the network 20c. The console 12 communicates with the network 20d through an Internet connection indicated generally by a cloud 28. The network 20d also includes a firewall 30 disposed between the Internet 28 and the network 20d. As will be discussed more fully hereinbelow, the console 12 sends instructions to the agents 18a, 18b, 18c, 18d to perform tests to probe the security vulnerabilities of the networks 20a, 20b, 20c, 20d. These tests may include the scanning of the networks 20a, 20b, 20c, 20d, fingerprinting, port scanning, protocol identification, and test cases execution.

The results of the tests performed by the agents 18a, 18b, 18c, 18d are reported back to the console 12 along the lines 22a, 22b, 22c, and 22d. The console 12 then transmits the results of the tests to the repository 14 along a line 32, where they are stored. The report generator 16 is coupled by a line 34 to the repository 14, and generates various reports in response to user input. The reports detail the security vulnerabilities of the networks 20a, 20b, 20c, 20d that the agents 18a, 18b, 18c, 18d have detected. The reports, once consolidated, detail the vulnerability of the network system 21. As will be apparent to those of ordinary skill in the art, the networks 20a, 20b, 20c, 20d may be configured in many different combinations of elements, and the networks 20a, 20b, 20c, 20d of the Figures are merely illustrative of an exemplary network system 21.

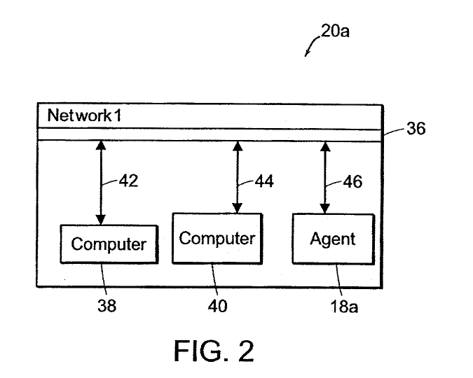

FIG. 2 is a detailed block diagram of the network 20a of FIG. 1. The network 20a includes a connection such as a cable or wireless device 36, or other means known to persons of ordinary skill in the art, to which is connected a pair of computers 38, 40, via lines 42, 44, respectively. The agent 18a on the network 20a of FIG. 2 is generally a module or routine that has been loaded on a computer, typically of the same type as computers 38, 40, which may be personal computers (PC's), and connects to the cable 36 through a line 46.

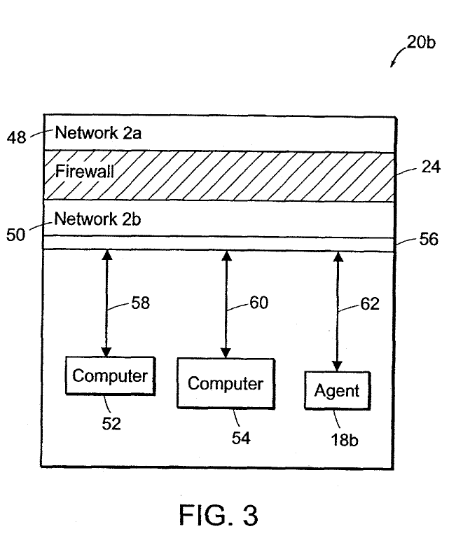

The network 20b of FIG. 3 includes the firewall 24 disposed between two sub-networks 48, 50, also identified on FIG. 3 as “network 2a” and “network 2b.” A pair of computers 52, 54 is connected to a bus 56 via lines 58, 60, respectively. The agent 18b is also connected to the bus 56 by a line 62.

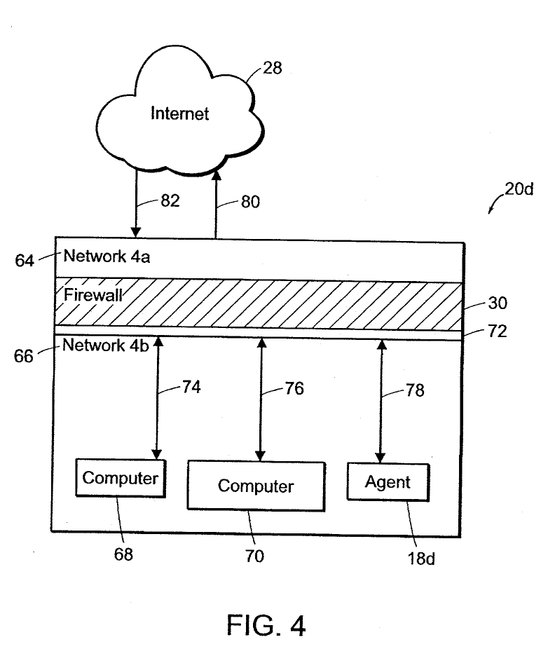

The network 20d of FIG. 4 includes a firewall 30 disposed between two sub-networks 64, 66. A pair of computers 68, 70 is connected to a bus 72 by lines 74, 76, respectively. The agent 18d is connected by a line 78 to the bus 72. It will be noted that the network 20d is connected to the Internet 28 by a pair of communication lines 80, 82. In the illustrated embodiment, communication is two-way between the Internet 28 and the network 20d. It will be recalled from FIG. 1 that the console 12 communicates with the agent 18d through the Internet 28 and the lines 80, 82.

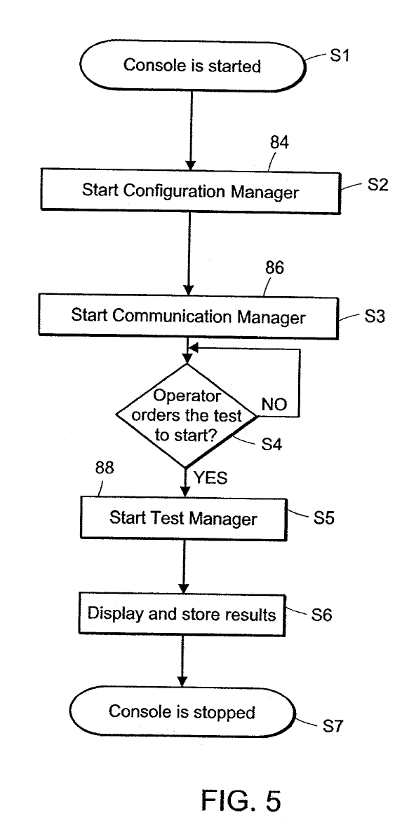

FIG. 5 is a flowchart for the console 12 of FIG. 1. Starting at step S1, the console 12 is started by an operator who desires to assess the security of the distributed network scanning architecture system 10. Once the console 12 is started at step S1, program flow continues at step S2, where a configuration manager 84 is started. Program flow then proceeds to step S3, where a communication manager 86 is started. As will be discussed more fully hereinbelow, the configuration manager 84 in step S2 is a routine or module that sends instructions to the agent 18a, 18b, 18c, 18d for the agent 18a, 18b, 18c, 18d to enter into a predefined configuration in order to perform security tests on the network 20a, 20b, 20c, 20d. The communication manager 86 of step S3 is a routine or module that provides communication between the console 12 and the agent 18a, 18b, 18c, 18d along the communication lines 22a, 22b, 22c, 22d of FIG. 1.

Returning to FIG. 5, program flow continues at step S4, where a decision is made as to whether the operator has ordered a test of the network system 21 to commence. If the operator has not ordered the test to commence, program flow returns to the preceding step, S4. Once the operator orders the test to begin, program flow continues at step S5, where a test manager 88 is initiated. As will be discussed more fully hereinbelow, the test manager 88 is a routine or module that sends instructions and commands to the agent 18a, 18b, 18c, 18d related to the tests to be run on the network 20a, 20b, 20c, 20d. After the test manager 88 has performed its tasks at step S5, program flow continues at step S6, where the console 12 displays and stores the results. It will be remembered from the previous discussion that the console 12 may display the results on a flat screen display or a CRT, and that the repository 14 stores the results of the tests. Program flow then continues at step S6, where the console 12 is stopped.

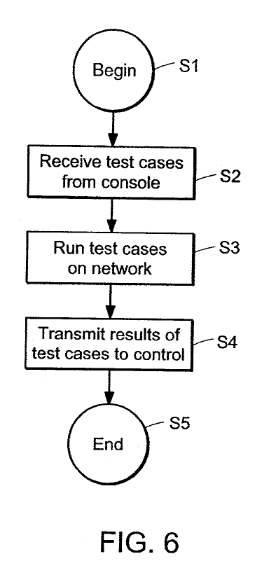

FIG. 6 is a flowchart for the agent 18a, 18b, 18c, 18d. Beginning at step S1, program flow proceeds to step S2, where the agent 18a, 18b, 18c, 18d receives test cases and other information from the console 12. Information from the console 12 configures the agent 18a, 18b, 18c, 18d to run the tests used to probe the vulnerabilities of the network 20a, 20b, 20c, 20d. Once the agent 18a, 18b, 18c, 18d has been properly configured at step S2, program flow continues at step S3, where the agent 18a, 18b, 18c, 18d runs the tests on the network 20a, 20b, 20c, 20d. Once the agent 18a, 18b, 18c, 18d has run the tests on the network 20a, 20b, 20c, 20d, program flow continues at step S4, where the agent 18a, 18b, 18c, 18d transmits the results of the test cases to the console 12. Program flow then ends at step S5.

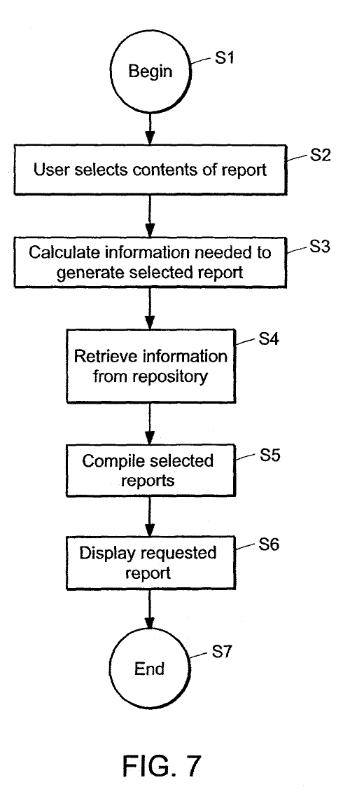

FIG. 7 is a flowchart for the report generator 16 of FIG. 1. Program flow commences at step S1, and continues at step S2, where the operator selects the contents of the report desired. An operator may select any appropriate configuration for the report, depending upon the status of the network system 21 he wishes to view. The report generator 16 may be operated in a batch mode, in which the report generator generates a report on the overall security of the network system 21 once all the agents 18a, 18b, 18c, 18d have reported the results of the tests, or in an interactive mode, in which the report generator 16 generates a report on each network 20a, 20b, 20c, 20d as the scanning operation performed by each agent 18a, 18b, 18c, 18d progresses. Once the operator has selected the contents of the report at step S2, program flow continues at step S3, where the report generator 16 calculates the information needed to generate the selected report. Once the report generator 16 has calculated the information at step S3, program flow continues at step S4, where the report generator 16 retrieves the information stored in the repository 14 along the line 34. At step S5, the report generator 16 compiles the selected reports from the information retrieved from the repository 14. Once the report generator 16 has compiled the selected reports at step S5, program flow continues at step S6, where the report generator 16 displays the requested report. As noted hereinbefore, the report generator 16 may display the report at step S6 on a monitor, such as a flat screen display or CRT, or it may print out the report on an attached printer (not shown). Various methods of displaying the requested information will occur to those of ordinary skill in the art. Once the report generator 16 has displayed the requested report at step S6, program flow terminates at step S7.

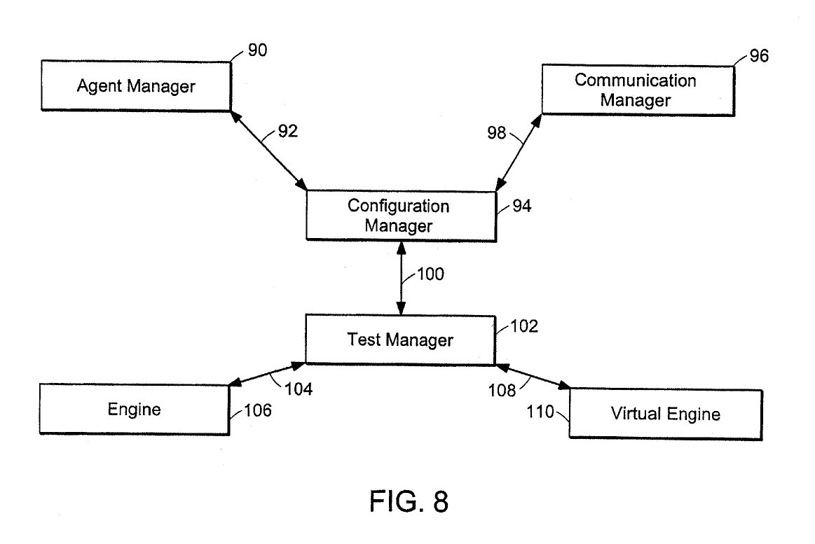

FIG. 8 is a block diagram showing the modules that perform the functions of the console 12 of FIG. 1. The console 12 includes an agent manager 90 that communicates with various other modules in the console 12, which communication is indicated diagrammatically on FIG. 8 by a line 92. The agent manager 90 communicates along the line 92 with a configuration manager 94. The configuration manager 94 exchanges information with a communication manager 96 along a line 98. The configuration manager 94 also communicates along a line 100 with a test manager 102. The test manager 102 communicates along a line 104 with an engine 106, which may also be identified as a local engine 106, that is, it is considered local as regards the console 12. The test manager 102 also communicates along a line 108 with a virtual engine 110. The functions of the modules of FIG. 8 will be explained more fully hereinbelow.

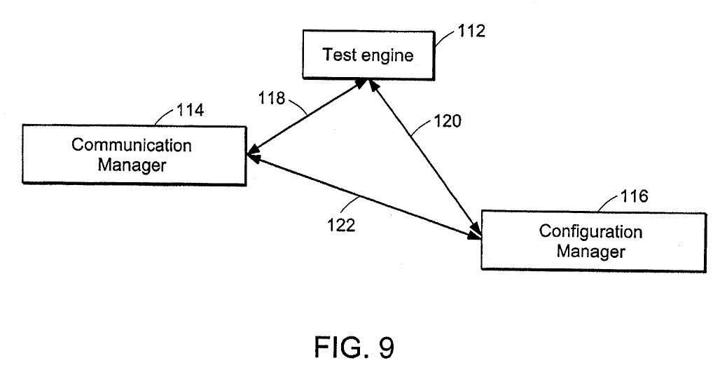

FIG. 9 is a functional block diagram showing the modules or routines of the agent 18a, 18b, 18c, 18d. A test engine 112 communicates with a communication manager 114 and a configuration manager 116 along lines 118 and 120, respectively. In addition, the communication manager 114 and the configuration manager 116 communicate along a line 122. The functions of the modules of FIG. 9 will be explained more fully hereinbelow.

It will be appreciated that the various lines of FIGS. 8 and 9 are not electrical connections, but rather, are diagrammatic representations of communications where information flows.

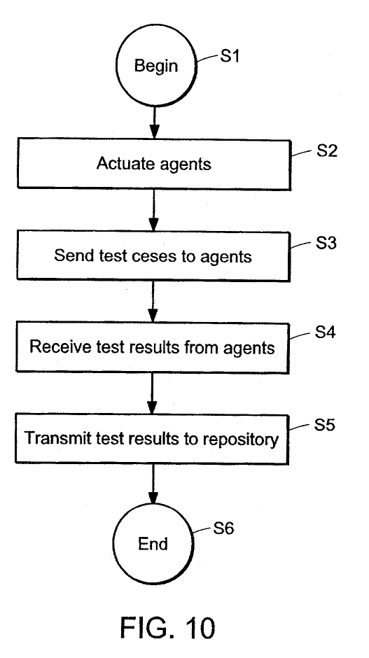

FIG. 10 is a flowchart for the program of the test manager 102 of FIG. 8. Beginning at step S1, program flow continues at step S2, where the test manager 102 initializes the agent 18a, 18b, 18c, 18d on the network 20a, 20b, 20c, 20d. Program flow continues at step S3, where the test manager 102 sends test cases to the agent 18a, 18b, 18c, 18d. As will be explained more fully hereinbelow, these test cases are used actively to test or probe the vulnerabilities of the network 20a, 20b, 20c, 20d. Program flow then proceeds to step S4, where the test manager 102 receives the test results from the agent 18a, 18b, 18c, 18d. Once the test manager 102 has received the test results from the agent 18a, 18b, 18c, 18d at step S4, program flow then proceeds to step S5, where the test manager 102 transmits the test results to the repository 14. Once the test manager 102 has transmitted the test results to the repository 14 at step S5, program flow terminates at step S6.

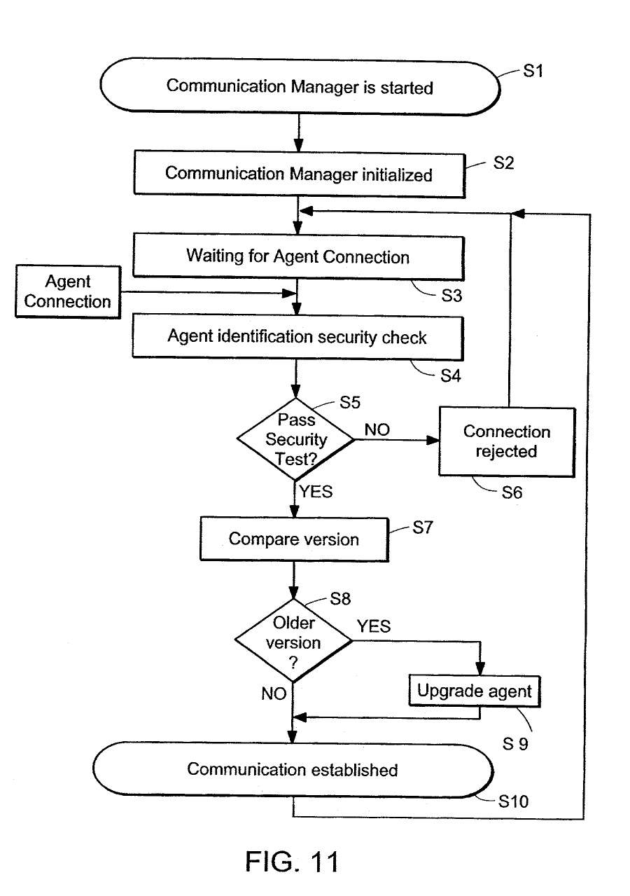

Turning now to FIG. 11, a flowchart for the program of the communication manager 96 of FIG. 8 is illustrated. Program flow for the communication manager 96 commences at step S1. Once the communication manager 96 is started at step S1, program flow continues at step S2, where the communication manager 96 is initialized. Program flow then continues at step S3, where the communication manager 96 waits for the connection to the agent 18a, 18b, 18c, 18d. Once the communication manager 96 receives an indication it is connected with the agent 18a, 18b, 18c, 18d, program flow continues at step S4, where the communication manager 96 does a security check to identify the agent 18a, 18b, 18c, 18d with which it is communicating. Program flow then continues at step S5, where the communication manager 96 tests to determine whether the agent identification security check in step S4 has been successfully passed. If the agent identification security check performed at step S4 does not pass the test at step S5, the connection with the agent 18a, 18b, 18c, 18d is rejected at step S6. Program flow then returns to step S3. If, however, the agent identification security check performed at step S4 is successful, program flow proceeds to step S7, where the communication manager 96 checks the version for the software of the agent 18a, 18b, 18c, 18d. At step S8, program flow tests whether the agent 18a, 18b, 18c, 18d is running an older version of the software. If it is, program flow continues at step S9. If the agent 18a, 18b, 18c, 18d is running an older version of the software, the communication manager 96 transmits a software upgrade to the agent 18a, 18b, 18c, 18d to upgrade the software running on the agent 18a, 18b, 18c, 18d. If the agent 18a, 18b, 18c, 18d is running the most current version of the software, as determined by step S8, program flow continues at step S110, where communication with the agent 18a, 18b, 18c, 18d is established. Once communication with the agent 18a, 18b, 18c, 18d is established at step S10, program flow continues at step S3.

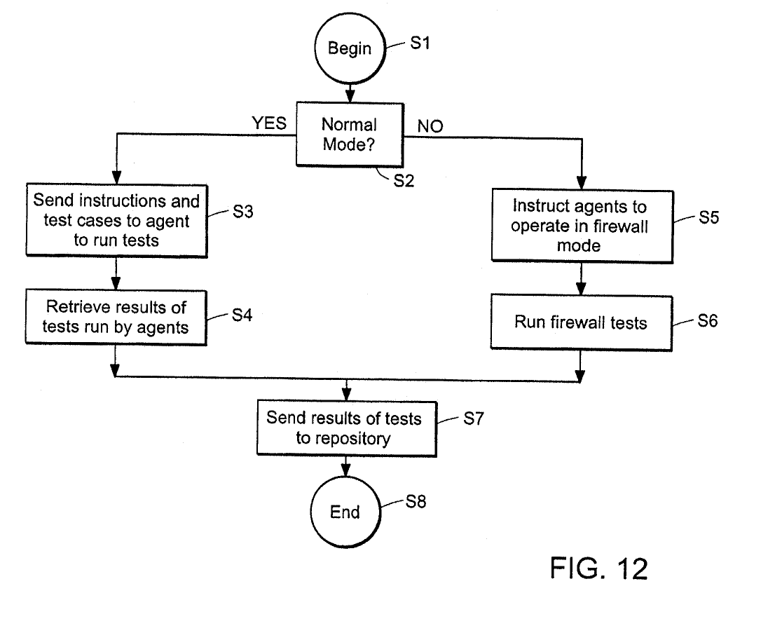

FIG. 12 is a flowchart for an alternate embodiment of the distributed network scanning architecture system 10 of the present invention. The distributed network scanning architecture system 10 is said to operate in both firewall and normal modes. The distributed network scanning architecture system 10 can perform separate, mutually exclusive functions of testing (1) the integrity of the firewalls 24, 26, 30 and (2) the general security of the network system 21. In the firewall mode, the distributed network scanning architecture system 10 is configured to probe the vulnerabilities of the firewalls 24, 26, 30 in the networks 20b, 20c, and 20d, respectively. In the normal mode, the console 12 is configured to probe the system 21 for vulnerabilities.

Referring now to the flowchart of FIG. 12, program flow commences at step S1, where it continues at a decision step S2. If the console 12 has set the distributed network scanning architecture system 10 to operate in the normal mode, program flow continues at step S3, where the console 12 sends instructions to send test cases to the agent 18a, 18b, 18c, 18d to run tests to probe the vulnerability of the network system 21. Program flow then continues at step S4, where the console 12 retrieves the results of the tests run by the agent 18a, 18b, 18c, 18d. As discussed more fully hereinabove, the report generator 16 generates a report on the vulnerability of the network system 21 as a result of the tests run by the agent 18a, 18b, 18c, 18d.

Returning now to step S2, if the console 12 has set the distributed network scanning architecture system 10 to operate in the firewall mode, program flow continues at step S5, where the console 12 sends instructions to the agent 18a, 18b, 18c, 18d so that it also operates in the firewall mode. Program flow then continues at step S6, where the console 12 and the agent 18a, 18b, 18c, 18d run tests to determine the integrity of the firewalls 24, 26, 30 to external attack. In this mode, the console 12 attempts to hack into the networks 20b, 20c and 20d behind the firewalls 24, 26, 30, respectively. The agents 18b, 18c, 18d then report the results of the tests to the console 12. It will be appreciated that, when the distributed network scanning architecture system 10 is operated in the normal mode, test results are not affected by the firewalls 24, 26, 30. In such an instance, of course, no information on the integrity of the firewalls 24, 26, 30 is reported to the console 12. However, when the distributed network scanning architecture system 10 is operated in the firewall mode, the integrity of the firewalls 24, 26, 30 is reported to the console 12.

Once the console 12 has completed its operations in either the firewall or the normal modes, as indicated at steps S4 and S6, respectively, program flow continues at step S7, where the results of the tests are transmitted from the console 12 to the repository 14. Program flow then terminates at step S8.

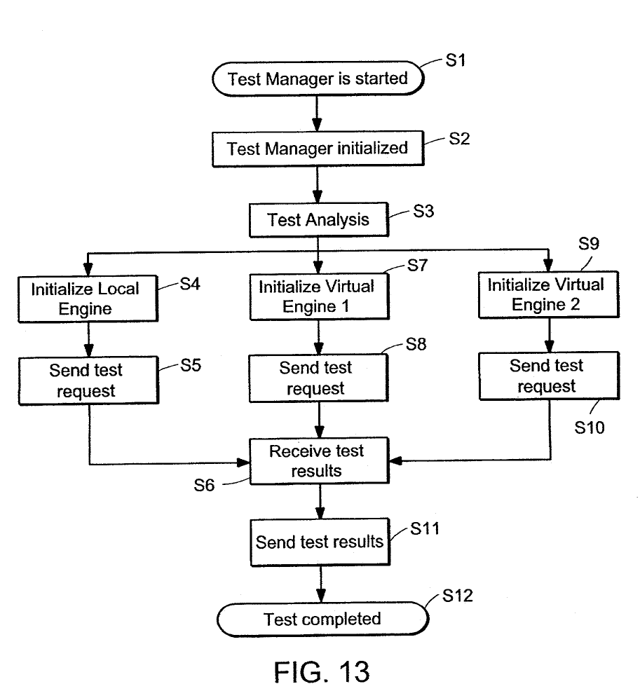

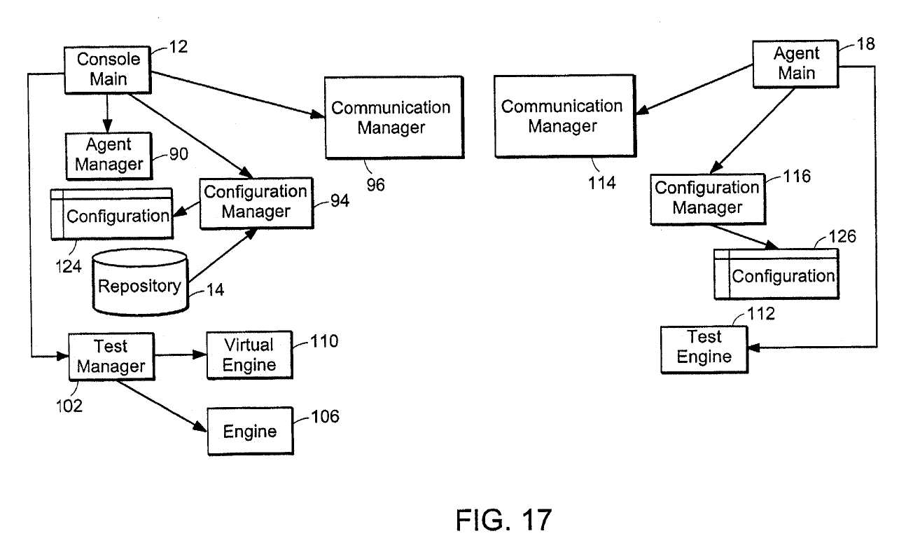

Turning now to FIG. 13, a flow chart for the test manager 102 is disclosed. Program flow commences at step S1, where the test manager 102 is started. Program flow then proceeds to step S2, where the test manager 102 is initialized. When the console 12 sends a test request to the test manager 102, program flow proceeds to step S3, where the test manager 102 begins a test analysis. Depending upon the test request from the console 12, the test manager 102 may proceed to step S4, where it initializes the local engine 106 (see FIG. 17). Program flow then continues at step S5, where the test manager 102 sends a test request to the local engine 106. After the local engine 106 has run the requested test, it reports the test results back to the test manager 102 at step S6.

The console 12 may send a test request to the test manager 102 that requires a virtual engine 110. (See FIG. 17.) As described more fully hereinbelow, the virtual engine 110 functions in a fashion similar to a proxy-engine, that is, it communicates with the engine in a remotely located agent 18a, 18b, 18c, 18d, so that the test manager 102 functions as if the remote engine were local. In this instance, program flow continues from step S3 to step S7, where the test manager 102 initializes the virtual engine 110. Program flow then continues at step S8, where the test manager 102 sends a test request to the virtual engine 110. After the virtual engine 110 has run the requested test, it transmits the test results back to the test manager 102, where they are received at step S6.

The console 12 may send a test request to the test manager 102 that requires the test manager 102 to initialize a second virtual engine 110. If this occurs, program flow continues from step S3 to step S9, where the test manager 102 initializes the second virtual engine 110. Program flow then continues at step S10, where the test manager 102 sends a test request to the second virtual engine 110. After the second virtual engine 110 has performed the requested test, it reports the results of the test back to the test manager 102, which receives the test results at step S6.

After the test manager 102 has received the test results at step S6, program flow continues at step S11, where the test manager 102 sends the test results back to the configuration manager 94. Program flow then continues at step S12, where the test is considered completed.

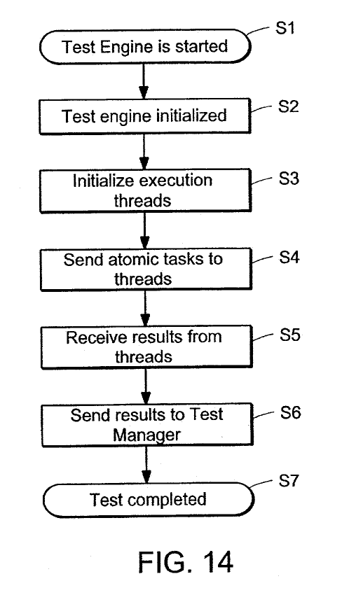

FIG. 14 is a flow chart for the test engine 106. Program flow commences at step S1, where the test engine 106 is started. Program flow then continues at step S2, where the test engine 106 is initialized. Once the test engine 106 receives a test request from the test manager 102, the test engine 106 initializes, at step S3, the execution threads necessary to perform the requested test. Program flow then continues at step S4, where the test engine 106 sends atomic tasks to the threads. Program flow then continues at step S5, where the test engine 106 receives the results from the threads. Program flow then continues at step S6, where the test engine 106 sends the results to the test manager 102. Program flow then continues at step S7, where the test is completed, and the test engine 106 is stopped.

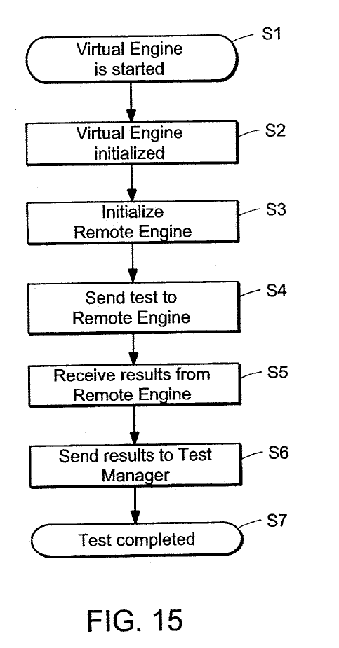

FIG. 15 is a flow chart for the virtual engine 110. Program flow commences at step S1, where the virtual engine 110 is started. Program flow then continues at step S2, where the virtual engine 110 is initialized in response to a message from the test manager 102. Program flow then continues at step S3, after the test manager 102 sends a test request to the virtual engine 110, where the virtual engine 110 initializes a remote engine 112. Program flow then continues at step S4, where the virtual engine 110 sends a test to the remote engine 112. Program flow then continues at step S5, where the virtual engine 110 receives the results of the tests run by the remote engine 112. Program flow then continues at step S6, where the virtual engine 110 sends the results to the test manager 102. After step S6, program flow continues at step S7, where the test is completed, and the virtual engine 110 is stopped.

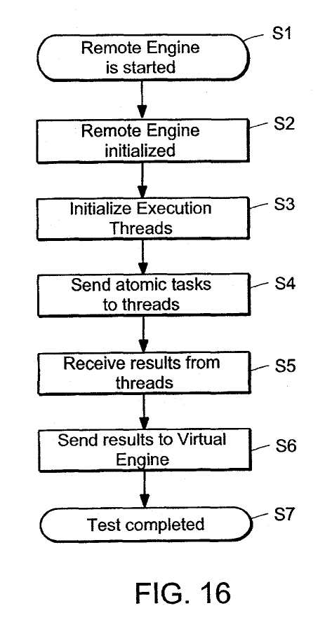

FIG. 16 is a flow chart for the remote engine 112. At step S1, program flow commences when the remote engine 112 is started. Program flow then continues at step S2, where the remote engine 112 is initialized. Program flow then continues at step S3, where the remote engine 112 responds to a test request from the virtual engine 110 to initialize the execution threads and carry out the test request. Program flow then continues at step S4, where the remote engine 112 sends the atomic tasks to the threads. Program flow continues at step S5, where the remote engine 112 receives the results from the threads. Program flow then continues at step S6, where the remote engine 112 sends the results to the virtual engine 110. Program flow then terminates at step S7, when the test is completed.

It will be appreciated from the above that the distributed network scanning architecture system 10 of the present invention is based upon 2 components, agents 18a, 18b, 18c, 18d, and a central console 12. The agents 18a, 18b, 18c, 18d are distributed throughout the network system 21. An agent's 18a, 18b, 18c, 18d task is to perform tests as instructed by the console 12. The console 12 controls the operations of the agents 18a, 18b, 18c, 18d, and can be operated through a graphical interface in the interactive mode or in batch. In the batch mode, the console 12 performs the tests at predetermined intervals, if desired, to assess the overall security of the network system 21. In the interactive mode, on the other hand, the operator can instruct the console 12 to run tests on selected sub-networks 20a, 20b, 20c, 20d.

The console 12's tasks are to manage the communication with and the configuration of the test engines 106, 112, both local 106, and remote 112, to distribute the tasks between the local and remote engines 106, 112, respectively, to store the results in the repository 14, and to give the operator real-time feedback on the scan process progress in interactive mode.

The components of the distributed network scanning architecture system 10 are composed of modules. Modules common to both the console 12 and the agent 18a, 18b, 18c, 18d are the test engine 106, 112, the communication manager 96, 114, and the configuration manager 94, 116.

The modules unique to the console 12 include the agent manager 90, the test manager 102, and the virtual engine 110.

The test engine 106, 112 has the following functions (1) scanning of network 20a, 20b, 20c, 20d, (2) fingerprinting, (3) port scanning, (4) protocol identification, and (5) test cases execution.

A test engine 106, 112 is a software module or subroutine that functions as a “sequencer” to receive high-level commands from the test manager 102, to break these tasks into atomic, i.e., smaller, tasks that are compiled into a pool of threads in the proper sequence, and finally, to send back the results of the tasks to the test manager 102 (or caller). The test engine 106, 112 enforces the execution rules under its own direction, that is, the test engine 106, 112 itself can decide whether or not a test case should be executed against a target host or computer, depending upon the host attributes and the previous test results on that host.

The communication manager 96, 114 is responsible for all tasks involving access to the network 20a, 20b, 20c, 20d through the Windows sockets or the raw packet driver. It is involved in performing all the low-level networking tasks during the test cases execution, and handling the communication between the console 12 and the remote agents 18a, 18b, 18c, 18d. The bi-directional communication between the remote agents 18a, 18b, 18c, 18d and the console 12 across a firewall 24, 26, 30 must be secure and optimized. Security is generally maintained by using an SSL 3.0 encryption algorithm for the communications. Small packets of information are compacted and buffered in order to optimize communications exchanged between the agents 18a, 18b, 18c, 18d and the console 12.

The configuration manager 94 is responsible for the objects describing the current configuration. The configuration manager 94 responds to requests for information from other modules 94, 96, 106, 110, such as the test cases, the hosts to be tested, the services running on these hosts, and the various test parameters for the tests to be performed.

The agent manager 90 receives connections from the remote agents 18a, 18b, 18c, 18d, and initiates synchronization between each of them and the console 12. The test manager 102 receives test requests from the console main program 12, analyzes the requests, breaks the tests into sub-parts for each engine 106, 110, involved, starts the required local or virtual engine 106, 110, sends sub-test requests to the appropriate local or virtual engines 106, 110, coordinates the test results, and forwards them to the configuration manager 94.

When the engine 112 in the remote agent 18a, 18b, 18c, 18d is involved in a test, the test manager 102 starts the virtual engine 110. The virtual engine 110 does not actually perform any tests, but is responsible for communicating with the remote agents 18a, 18b, 18c, 18d involved in the test, sending test requests to the engine 112 in the remote agent 18a, 18b, 18c, 18d, and receiving the test results. It acts in a fashion similar to a proxy-engine, that is, it hides the engine 112 use in the remote agent 18a, 18b, 18c, 18d for the test manager 102.

Turning now to FIGS. 17 through 20, the dynamics of the distributed network scanning architecture system 10 are depicted. It will be noted that a particular configuration 124 is supplied to the configuration manager 94 in the console 12 and a corresponding configuration 126 is supplied to the configuration manager 116 in the agent 18a, 18b, 18c, 18d.

The console 12 is started and the following actions occur, as shown in FIG. 17. The configuration manager 94 in the console 12 is started, and sets up the objects describing the global environment (i.e., test cases, global test parameters, etc.) by reading the repository 14. The communication manager 96 is initialized. The agent manager 90 is started, awaiting connection with the remote agents 18a, 18b, 18c, 18d.

A remote agent 18a, 18b, 18c, 18d is started and the following occurs, also as shown in FIG. 17. The configuration manager 94 is started and set up with local information, the most important being the address and port number of the console 12 to which it is to connect. The agent 18a, 18b, 18c, 18d starts its communication manager 114, and immediately tries to connect to the console 12.

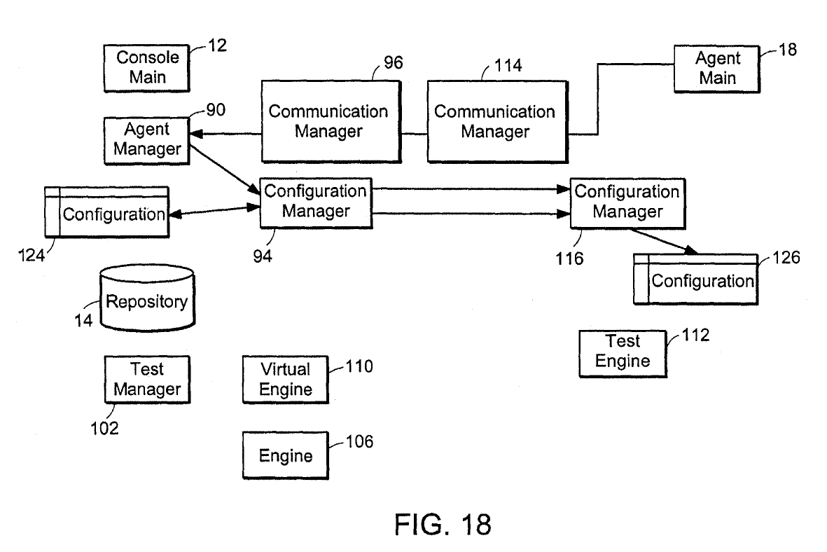

FIG. 18 depicts the state of the distributed network scanning architecture system 10 when communication is established between the console 12 and the agent 18a, 18b, 18c, 18d, and when the two configurations 124, 126 are synchronized. When communication is established, the agent 18a, 18b, 18c, 18d continuously tries to connect to the console 12. When the communication manager 96 receives a connection, it validates the initiator, and passes it to the agent manager 90. Once communication is established, the two configurations 124, 126 must be synchronized. This occurs when the agent manager 90 activates the configuration manager 94 of the console 12, which connects to the configuration manager 116, its agent counterpart. The configuration information 124, 126 is exchanged, synchronizing the two configuration managers 94, 116. During this phase, executable files (e.g., new test cases, new versions for the agent 18a, 18b, 18c, 18d) can be advantageously transferred to the agent 18a, 18b, 18c, 18d. The agent 18a, 18b, 18c, 18d is now ready to participate in subsequent tests of the network 20a, 20b, 20c, 20d.

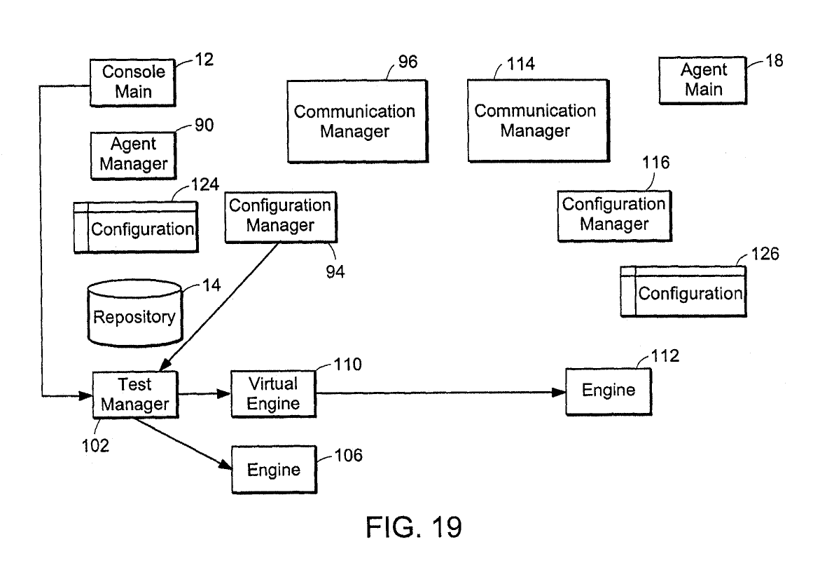

Referring to FIG. 19, the console 12 starts the test by sending a test request to the test manager 102. The test manager 102 requests information from the configuration manager 94, and breaks the test into sub-tests to be performed locally, in which case, a local test engine 106 is then started. If the tests are to be performed remotely, a remote agent 18a, 18b, 18c, 18d is instructed to start a test engine 112. If part of the test is to be performed locally, the test manager 102 starts a local engine 106 and passes the corresponding sub-test definition to it. If part of the test is to be performed remotely, by remote agents 18a, 18b, 18c, 18d, the test manager starts a virtual engine 110. The virtual engine 110 does not perform the test itself, but is responsible for communicating with the remote agents 18a, 18b, 18c, 18d. It begins by transferring the sub-test definition to the corresponding engine in the remote agent 18a, 18b, 18c, 18d.

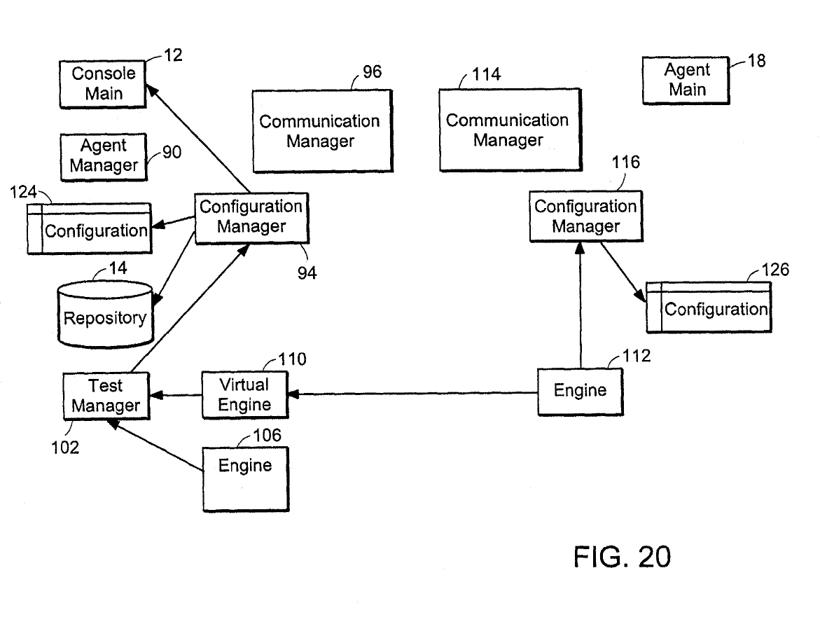

FIG. 20 illustrates the network modules actually running the test. Once each engine 106, 110, 112 has enough information to perform its part of the test, the test engine 112, local or remote 106, 112, breaks the sub-tests into atomic tasks and assigns these tasks to threads in its pool. These tasks may be port scanning, fingerprinting, performing test cases, or the like. The results are treated locally to enforce execution rules, i.e., the results of the tasks impact subsequent behavior of the engine 106, 112. The engine 112 in the remote agent 18a, 18b, 18c, 18d sends back its results to its virtual engine 110 in the console 12, which then passes it back to the test manager 102. The communication between the remote engine 112 and the virtual engine 110 is asynchronous and optimized. The local engine 106 sends back its results to the test manager 102. The test manager forwards information to the configuration manager 94 that updates the configuration 124, notifies the console 12 of the new configuration 124, and stores the relevant results in the repository 14 at the end of the test.

Still further, it will be appreciated that a distributed network scanning architecture system 10 in accord with the present invention avoids the problems of bottlenecks and infrequent scanning operations inherent in prior art active, but not distributed, scanning systems. The distributed network scanning architecture system 10 in accord with the present invention can test a network system 21 with firewalls 24, 26, 30 without compromising the results of the tests, unlike prior art active systems, and can even test the integrity of the firewalls 24, 26, 30. The distributed network scanning architecture system 10 in accord with the present invention can generate a single report for the entire network system 21 without complicated intervention and manipulation by an operator.

Although preferred embodiments of the present invention have been described in detail herein with reference to the accompanying drawings, it is to be understood that the invention is not limited to those precise embodiments, and that various changes and modifications may be effected therein by one skilled in the art without departing from the spirit and scope of the invention as defined in the appended claims.

1. A system for assessing the vulnerability of a network comprising:
a central console; and
an agent disposed on said network for performing active tests under control of said central console, said agent communicating the results of said tests to said central console.

2. The system of claim 1, wherein said agent includes a module for performing tests to probe the vulnerability of said network to attack.

3. The system of claim 2, wherein said network includes a plurality of computers connected thereto, and wherein said agent includes a module for collecting information about said computers to assess said vulnerability of said network.

4. The system of claim 3, wherein said agent includes a module for running test cases on said computers to assess said vulnerability of said network.

5. The system of claim 4, and further comprising a plurality of said agents disposed on said network.

6. The system of claim 5, and further comprising a repository for storing said results of said tests.

7. The system of claim 6, and further comprising a module for providing a report on said security of said network in response to said stored results.

8. The system of claim 7, wherein said network includes a plurality of sub-networks, and wherein said network includes a firewall for at least one sub-network, and wherein said central console is disposed outside said firewall and includes a module for performing tests to simulate attacks on said sub-network by a hacker.

9. The system of claim 7, wherein said central console includes a console main module for directing the operation of said central console.

10. The system of claim 7, wherein said central console includes a communication manager for managing all tasks involving access to said network by said central console.

11. The system of claim 10, wherein said agent includes a communication manager for managing tasks involving access to said network by said agent.

12. The system of claim 11, wherein said central console includes an agent manager for receiving and synchronizing communications with said agents.

13. The system of claim 12, wherein said central console has a plurality of configurations, and said central console includes a configuration manager for synchronizing said agents and said console configurations.

14. The system of claim 13, wherein said network includes a plurality of sub-networks, and wherein said central console is disposed on one of said sub-networks and includes a test engine for performing tests locally on said sub-network.

15. The system of claim 14, wherein said central console includes a virtual engine for performing network tests through said agents located remotely on said network.

16. The system of claim 15, wherein said central console includes a test manager for receiving test requests from said console, initializing said test engines to run said tests on said network in response thereto, coordinating said results of said test engines, and forwarding said results to said configuration manager.

17. The system of claim 16, wherein said agent includes an agent main for receiving and synchronizing communications with said central console.

18. The system of claim 17, wherein said agent main includes a configuration manager for synchronizing said agents and said console configurations.

19. The system of claim 18, wherein said agent includes an engine for performing tests on said network.

20. The system of claim 19, wherein said agents include an encryption module for encrypting said results of said tests.

21. A method of assessing the security of a network comprising the steps of:
deploying an agent on said network; and
directing said agent from a central console to run tests on said network to assess the vulnerability of said network.

22. The method of claim 21, wherein said step of directing said agent includes the step of directing said agent to perform active tests to probe said vulnerability of said network to attack.

23. The method of claim 22, wherein said step of directing said agent includes the step of directing said agent to collect information about computers connected to said network to assess said vulnerability of said network.

24. The method of claim 23, wherein said step of directing said agent includes the step of directing said agent to run test cases on said computers to assess said vulnerability of said network.

25. The method of claim 24, wherein said step of deploying said agents includes the step of deploying a plurality of said agents on said network.

26. The method of claim 25, and further comprising the step of communicating the results of said tests run by said agents to said central console.

27. The method of claim 26, and further comprising the step of compiling said results of said tests at said central console.

28. The method of claim 27, and further comprising the step of providing a report on said security of said network in response to said step of compiling.

29. The method of claim 28, and further comprising the steps of positioning a firewall between said central console and at least one sub-network of said network, and performing tests from said central console to simulate attacks on said sub-network by a hacker.

30. The method of claim 28, and further comprising the step of encrypting said results of said tests run by said agents before said step of communicating said results to said central console.

31. A network security system comprising:
a central console;
an agent disposed on said network for performing active tests under control of said central console, said agent communicating the results of said tests to said central console; and
report means for providing a report on said security of said network in response to said results of said tests.

32. The network security system of claim 31, wherein said agent includes a module for performing tests to probe the vulnerability of said network to attack.

33. The network security system of claim 32, wherein said network includes a plurality of computers connected thereto, and wherein said agent includes a module for collecting information about said computers to assess said vulnerability of said network.

34. The network security system of claim 33, wherein said agent includes a module for running test cases on said computers to assess said vulnerability of said network.

35. The network security system of claim 34, and further comprising a plurality of said agents disposed on said network.

36. The network security system of claim 35, and further comprising a repository for storing said results of said tests, and wherein said report means includes a report generator coupled to said repository for generating reports from said stored results.

37. The network security system of claim 36, wherein said report generator includes means for providing a written report on said security of said network.

38. The network security system of claim 37, wherein said network includes a plurality of sub-networks, and wherein said network includes a firewall for at least one sub-network, and wherein said central console is disposed outside said firewall and includes a module for performing tests to simulate attacks on said sub-network by a hacker.

39. The network security system of claim 37, wherein said central console includes a console main module for directing the operation of said central console.

40. The network security system of claim 37, wherein said central console includes a communication manager for managing all tasks involving access to said network by said central console.

41. The network security system of claim 40, wherein said agent includes a communication manager for managing tasks involving access to said network by said agent.

42. The network security system of claim 41, wherein said central console includes an agent manager for receiving and synchronizing communications with said agents.

43. The network security system of claim 42, wherein said central console has a plurality of configurations, and said central console includes a configuration manager for synchronizing said agents and said console configurations.

44. The network security system of claim 43, wherein said network includes a plurality of sub-networks, and wherein said central console is disposed on one of said sub-networks and includes a test engine for performing tests locally on said sub-network.

45. The network security system of claim 44, wherein said central console includes a virtual engine for performing network tests through agents located remotely on said network.

46. The network security system of claim 45, wherein said central console includes a test manager for receiving test requests from said console, initializing said test engines to run said tests on said network in response thereto, coordinating said results of said test engines, and forwarding said results to said configuration manager.

47. The network security system of claim 46, wherein said agent includes an agent main for receiving and synchronizing communications with said central console.

48. The network security system of claim 47, wherein said agent main includes a configuration manager for synchronizing said agents and said console configurations.

49. The network security system of claim 48, wherein said agent includes an engine for performing tests on said network.

50. The network security system of claim 49, wherein said agents include an encryption module for encrypting said results of said tests.

51. A network security assessment method comprising the steps of:
deploying an agent on said network;
directing said agent from a central console to run active tests on said network to assess the vulnerability of said network; and
compiling said results of said tests.

52. The method of claim 51, wherein said step of directing said agent includes the step of directing said agent to perform active tests to probe said vulnerability of said network to attack.

53. The method of claim 52, wherein said step of directing said agent includes the step of directing said agent to collect information about computers connected to said network to assess said vulnerability of said network.

54. The method of claim 53, wherein said step of directing said agent includes the step of directing said agent to run test cases on said computers to assess said vulnerability of said network.

55. The method of claim 54, wherein said step of deploying said agents includes the step of deploying a plurality of said agents on said network.

56. The method of claim 55, and further comprising the step of communicating the results of said tests run by said agents to said central console.

57. The method of claim 66, and further comprising the step of compiling said results of said tests at said central console.

58. The method of claim 57, and further comprising the step of providing a report on said security of said network in response to said step of compiling.

59. The method of claim 58, and further comprising the steps of positioning a firewall between said central console and at least one sub-network of said network, and performing tests from said central console to simulate attacks on said sub-network by a hacker.

60. The method of claim 59, and further comprising the step of encrypting said results of said tests run by said agents before said step of communicating said results to said central console.

61. A computer program product comprising a computer usable medium having computer readable program code means embodied in said medium for causing an application program to execute on a computer to provide an assessment of the vulnerability of a network of computers, said computer readable program code means comprising:
a first computer readable program code means executing on at least one computer on said network for performing active tests on said network; and
a second computer readable program code means for sending instructions to said first computer readable program code means to perform said tests and for receiving the results of said tests run by said first computer readable program code means.

62. The computer program product of claim 61, wherein said first computer readable program code means includes a computer readable program code means for performing tests to probe the vulnerability of said network to attack.

63. The computer program product of claim 62, wherein said network includes a plurality of computers connected thereto, and wherein said first computer readable program code means includes a computer readable program code means for collecting information about said computers to assess said vulnerability of said network.

64. The computer program product of claim 63, wherein said first computer readable program code means includes a computer readable program code means for running test cases on said computers to assess said vulnerability of said network.

65. The computer program product of claim 64, and further comprising a plurality of said first computer readable program code means disposed on a plurality of computers on said network.

66. The computer program product of claim 65, and further comprising a repository for storing said results of said tests.

67. The computer program product of claim 66, and further comprising a computer readable program code means for providing a report on said security of said network in response to said stored results.

68. The computer program product of claim 67, wherein said network includes a plurality of sub-networks, and wherein said network includes a firewall for at least one sub-network, and wherein said second computer readable program code means is disposed outside said firewall and includes a computer readable program code means for performing tests to simulate attacks on said sub-network by a hacker.

69. The computer program product of claim 67, wherein said second computer readable program code means includes a computer readable main program code means for directing the operation of said second computer readable program code means.

70. The computer program product of claim 67, wherein said second computer readable program code means includes a computer readable communication manager program code means for managing all tasks involving access to said network by said second computer readable program code means.

71. The computer program product of claim 70, wherein said first computer readable program code means includes a computer readable communications manager program code means for managing tasks involving access to said network by said first computer readable program code means.

72. The computer program product of claim 71, wherein said second computer readable program code means includes a computer readable agent manager program code means for receiving and synchronizing communications with said first computer readable program code means.

73. The computer program product of claim 72, wherein said second computer readable program code means has a plurality of configurations, and wherein said second computer readable program code means includes a computer readable configuration manager program code means for synchronizing said first computer readable program code means and said second computer readable program code configuration means.

74. The computer program product of claim 73, wherein said network includes a plurality of sub-networks, and wherein said second computer readable program code means is disposed on one of said sub-networks and includes a computer readable test engine program code means for performing tests locally on said sub-network.

75. The computer program product of claim 74, wherein said second computer readable program code means includes a computer readable virtual engine program code means for performing network tests through said first computer readable program code means located remotely on said network.

76. The computer program product of claim 75, wherein said second computer readable program code means includes a computer readable test manager program code means for receiving test requests from said computer readable main program code means, initializing computer readable test engine program code means to run said tests on said network in response thereto, coordinating said results of said computer readable test engine program code means, and forwarding said results to said second computer readable program code means.

77. The computer program product of claim 76, wherein said first computer readable program code means includes a computer readable agent main program code means for receiving and synchronizing communications with said second computer readable program code means.

78. The computer program product of claim 77, wherein said computer readable agent main program code means includes a computer readable configuration manager program code means for synchronizing said first computer readable program code means and said second computer readable program code configuration means.

79. The computer program product of claim 78, wherein said first computer readable program code means includes a computer readable engine program code means for performing tests on said network.

80. The computer program product of claim 79, wherein said first computer readable program code means include a computer readable encryption program code means for encrypting said results of said tests.

81. A computer data signal embodied in a carrier wave representing sequences of instructions which, when executed by a processor, assess the vulnerability of a network of processors, said computer data signal comprising:
a first program code segment executing on at least one processor on said network for performing active tests on said network; and
a second program code segment for sending instructions to said first program code segment to perform said tests and for receiving the results of said tests run by said first program code segment.

82. The computer data signal of claim 81, wherein said first program code segment includes a program code segment for performing tests to probe the vulnerability of said network to attack.

83. The computer data signal of claim 82, wherein said first program code segment includes a program code segment for collecting information about said processors to assess said vulnerability of said network.

84. The computer data signal of claim 83, wherein said first program code segment includes a program code segment for running test cases on said processors to assess said vulnerability of said network.

85. The computer data signal of claim 84, and further comprising a plurality of said first program code segments disposed on a plurality of said processors on said network.

86. The computer data signal of claim 85, and further comprising a program code segment for compiling said results of said tests.

87. The computer data signal of claim 86, and further comprising a program code segment for providing a report on said security of said network in response to said compiled results.

88. The computer data signal of claim 87, wherein said network includes a plurality of sub-networks, and wherein said network includes a firewall for at least one sub-network, and wherein said second program code segment is disposed outside said firewall and includes a program code segment for performing tests to simulate attacks on said sub-network by a hacker.

89. The computer data signal of claim 87, wherein said second program code segment includes a main program code segment for directing the operation of said second program code segment.

90. The computer data signal of claim 87, wherein said second program code segment includes a communication manager program code segment for managing all tasks involving access to said network by said second program code segment.

91. The computer data signal of claim 90, wherein said first program code segment includes a communications manager program code segment for managing tasks involving access to said network by said first program code segment.

92. The computer data signal of claim 91, wherein said second program code segment includes an agent manager program code segment for receiving and synchronizing communications with said first program code segment.

93. The computer data signal of claim 92, wherein said second program code segment has a plurality of configuration segments, and wherein said second program code segment includes a configuration manager program code segment for synchronizing said first program code segment and said second program code configuration segment.

94. The computer data signal of claim 93, wherein said network includes a plurality of sub-networks, and wherein said second program code segment is disposed on one of said sub-networks and includes a test engine program code segment for performing tests locally on said sub-network.

95. The computer data signal of claim 94, wherein said second program code segment includes a virtual engine program code segment for performing network tests through said first program code segments located remotely on said network.

96. The computer data signal of claim 95, wherein said second program code segment includes a test manager program code segment for receiving test requests from said main program code segment, initializing a test engine program code segment to run said tests on said network in response thereto, coordinating said results of said test engine program code segment, and forwarding said results to said second program code segment.

97. The computer data signal of claim 96, wherein said first program code segment includes an agent main program code segment for receiving and synchronizing communications with said second program code segment.

98. The computer data signal of claim 97, wherein said agent main program code segment includes a configuration manager program code segment for synchronizing said first program code segment and said second program code configuration segment.

99. The computer data signal of claim 98, wherein said first program code segment includes an engine program code segment for performing said tests on said network.

100. The computer data signal of claim 99, wherein said first program code segment includes an encryption program code segment for encrypting said results of said tests.
